(19) United States
(12) Patent Application Publication
(10) Pub. No.: US 2021/0201252 A1
(43) Pub. Date: Jul. 1, 2021

(54) SERVER APPARATUS, CONTROL APPARATUS, STORAGE MEDIUM, MOBILE SHOP, AND OPERATING METHOD FOR INFORMATION PROCESSING SYSTEM

(71) Applicant: TOYOTA JIDOSHA KABUSHIKI KAISHA, Toyota-shi (JP)

(72) Inventors: Ryosuke KOBAYASHI, Nagakute-shi (JP); Ayana TAKESHITA, Kasugai-shi (JP); Naoki YAMAMURO, Nagoya-shi (JP); Takuya MAEKAWA, Nagoya-shi (JP); Yugo SAKURAI, Setagaya-ku (JP)

(73) Assignee: TOYOTA JIDOSHA KABUSHIKI KAISHA, Toyota-shi (JP)

(21) Appl. No.: 17/123,346

(22) Filed: Dec. 16, 2020

(30) Foreign Application Priority Data
Dec. 25, 2019 (JP) 2019-234968

(51) Int. Cl. G06Q 10/08; G06Q 30/02

(52) U.S. Cl. CPC G06Q 10/087; G06Q 30/0207

(57) ABSTRACT

A server apparatus includes a communication interface and a controller configured to send and receive information via the communication interface. The controller, while a mobile shop which is configured to be loaded with items according to vacant spaces is loaded with one or more first items and performs patrol selling, sends a discount instruction, to the mobile shop, to discount the one or more first items upon receipt of a request, from a terminal apparatus, for patrol selling of a second item not loaded in the mobile shop.

### CROSS-REFERENCE TO RELATED APPLICATION

This application claims priority to Japanese Patent Application No. 2019-234968 (filed on Dec. 25, 2019), the entire contents of which are incorporated herein by reference.

### TECHNICAL FIELD

The present disclosure relates to a server apparatus, a control apparatus, a storage medium, a mobile shop, and an operating method for an information processing system.

### BACKGROUND

Various technologies for supporting selling of items in physical shops in the retail industry have been proposed. For example, Patent Literature (PTL) 1 discloses an information provision system for providing a consumer with information on items being sold in a shop to prompt the consumer to purchase the items.

### CITATION LIST

### Patent Literature

PTL 1: JP 11-353555 A

### SUMMARY

There is room for improvement in technologies for supporting selling of items in shops, in terms of improvement in convenience for consumers together with improvement in sales efficiency for vendors.

It would be helpful to provide a server apparatus and the like that may improve convenience for consumers together with sales efficiency when selling items in shops.

A server apparatus according to the present disclosure includes:

a communication interface; and

a controller configured to send and receive information via the communication interface.

While a mobile shop which is configured to be loaded with items according to vacant spaces is loaded with one or more first items and performs patrol selling, the controller sends a discount instruction, to the mobile shop, to discount the one or more first items upon receipt of a request, from a terminal apparatus, for patrol selling of a second item not loaded in the mobile shop.

A control apparatus of a mobile shop according to the present disclosure is mounted in a mobile shop that is configured to be loaded with items according to vacant spaces.

The control apparatus is configured to send and receive information with a server apparatus and control the mobile shop,

while the mobile shop is loaded with one or more first items and performs patrol selling, a discount instruction to discount the one or more first items is sent from the server apparatus upon receipt, by the server apparatus, of a request, from a terminal apparatus, for patrol selling of a second item not loaded in the mobile shop, and

upon receiving the discount instruction, the control apparatus outputs information for discounting the one or more first items.

An operating method for an information processing system according to the present disclosure is an operating method for an information processing system including a mobile shop configured to be loaded with items according to vacant spaces and a server apparatus configured to send and receive information with the mobile shop. The operating method includes:

sending, by the server apparatus, while the mobile shop is loaded with one or more first items and performs patrol selling, a discount instruction to discount the one or more first items upon receipt of a request, from a terminal apparatus, for patrol selling of a second item not loaded in the mobile shop; and

outputting, by the mobile shop, information for discounting the one or more first items upon receiving the discount instruction.

According to the server apparatus and the like of the present disclosure, it is possible to improve convenience for consumers together with sales efficiency when selling items in shops.

### BRIEF DESCRIPTION OF THE DRAWINGS

In the accompanying drawings:

FIG. 1 is a diagram illustrating a configuration example of an information processing system;

FIG. 2 is a diagram illustrating a configuration example of a server apparatus;

FIG. 3 is a diagram illustrating a configuration example of a mobile shop;

FIG. 4 is a diagram illustrating a configuration example of a consumer terminal apparatus;

FIG. 5A is a diagram illustrating an example of loading item information;

FIG. 5B is a diagram illustrating an example of loading space information;

FIG. 6 is a sequence diagram illustrating an operation example of the information processing system;

FIG. 7 is a sequence diagram illustrating another operation example of the information processing system; and

FIG. 8 is a flowchart illustrating an operation example of the server apparatus.

### DETAILED DESCRIPTION

Hereinbelow, an embodiment is described.

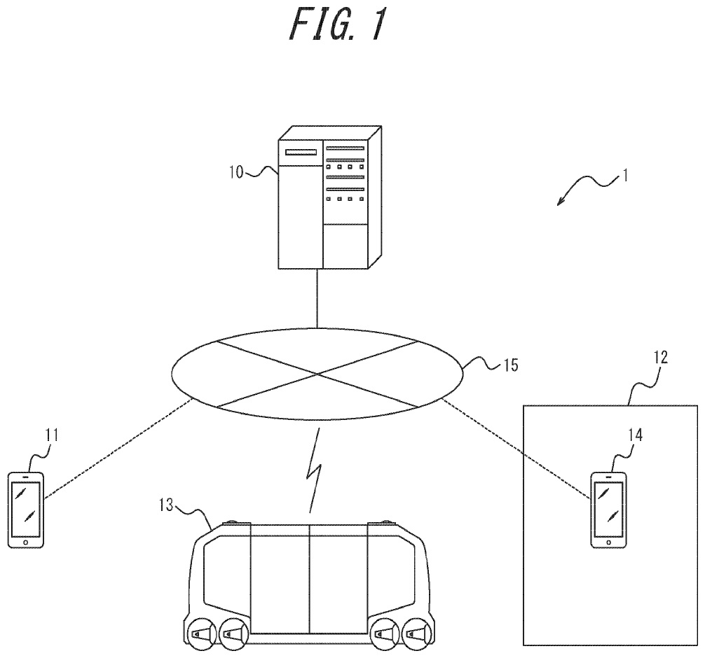

FIG. 1 is a diagram illustrating a configuration example of an information processing system according to an embodiment. An information processing system 1 is configured to assist in selling items in a mobile shop. For example, the information processing system 1 has at least one of each of a server apparatus 10, a terminal apparatus 11 to be used by a consumer (hereinafter referred to as the consumer terminal apparatus), a mobile shop 13, and a terminal apparatus 14 that is located at a hub 12 where items are to be loaded into the mobile shop 13 (hereinafter referred to as the hub terminal apparatus), all of which are connected via a network 15 so that they can communicate information with each other. The server apparatus 10 is a computer, for example, and is configured to send various operation instructions to the mobile shop 13 as well as functioning as a server that provides a website of an item vendor. For example, the consumer terminal apparatus 11 and the hub terminal apparatus 14 are each an information terminal apparatus such as a personal computer, a tablet terminal apparatus, or a smartphone. The mobile shop 13 is a multi-purpose vehicle equipped with a shop facility and control/communication functionality. The network 15 is the Internet, for example, but may also include an ad-hoc network, a LAN, a Metropolitan Area Network (MAN), other networks, or a combination of two or more thereof.

In outline, the information processing system 1 operates as follows. The mobile shop 13 performs patrol selling of items loaded at the hub 12 while traveling on a predetermined route, and arrives at the hub 12 to be loaded with items according to vacant loading spaces. The mobile shop 13 alternates between loading of items and patrol selling. The patrol route is, for example, a route which starts from the hub 12 and along which appropriate areas such as a residential street, a business street, and/or a downtown area are patrolled before reaching the hub 12, and is set freely by an item vendor. The patrol route may be a patrol route according to which the mobile shop 13 departs from one hub 12 and returns to the same hub 12, or may be a patrol route according to which the mobile shop 13 reaches a different hub 12. When the server apparatus 10 receives a request for patrol selling of an item not loaded in the mobile shop 13 from the consumer terminal apparatus 11, while the mobile shop 13 is patrol selling loaded items, the server apparatus sends, to the mobile shop 13, a discount instruction to discount the items the mobile shop 13 is currently patrol selling. Then, the mobile shop 13 discounts the items the mobile shop 13 is currently patrol selling.

With selling of items using the mobile shop 13, unlike with order/delivery type selling, a consumer might feel dissatisfied in a case in which the mobile shop 13 is not loaded with an item demanded by the consumer. On the other hand, from the standpoint of a vendor, in a case in which the consumer demands an item other than items the mobile shop 13 is currently patrol selling, it is preferable, for enhancement of business opportunities, that the mobile shop 13 is loaded with this item (hereinafter referred to as the demanded item) for the next patrol selling. It is necessary to make sufficient room in the loading space of the mobile shop 13 in order to load the demanded item in the loading space, which is limited. According to the present embodiment, by discounting the items that are currently subject to patrol selling, it is possible to reliably sell the items, create vacant loading spaces in the mobile shop 13, load demanded items which are expected to be sold into the vacant loading spaces, and perform the next patrol selling. Accordingly, it is possible to provide the demanded items to the consumer at an early timing together with enabling the vendor to enhance business opportunities.

Next, the configuration of each of the components of the information processing system 1 is described.

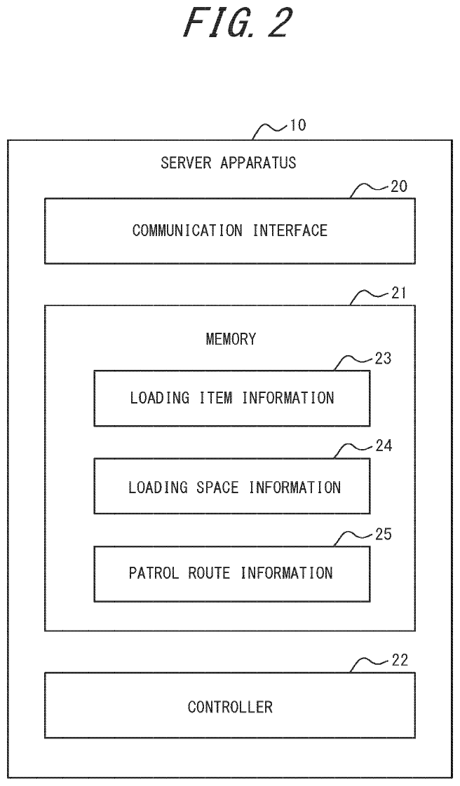

FIG. 2 illustrates a configuration example of the server apparatus 10. The server apparatus 10 includes a communication interface 20, a memory 21, and a controller 22. The server apparatus 10 may execute operations in the present embodiment by communicating and working in cooperation with another server apparatus having an equivalent configuration to the configuration of the server apparatus 10.

The communication interface 20 has one or more communication modules that are compatible with wired or wireless LAN standards for connecting to the network 15. In the present embodiment, the server apparatus 10 is connected to the network 15 via the communication interface 20 and communicates information with other apparatuses via the network 15.

The memory 21 has, for example, a semiconductor memory, a magnetic memory, or an optical memory. The memory 21 functions as a main memory, an auxiliary memory, or a cache memory, for example. The memory 21 is configured to store any information, control/processing programs, and the like used for operations of the server apparatus 10. For example, the memory 21 stores information 23 on items that are loaded into the mobile shop 13 for patrol selling (hereinafter referred to as the loading item information), information 24 indicating a vacant loading space status in the mobile shop 13 (hereinafter referred to as the loading space information), and information 25 on a patrol route (hereinafter referred to as the patrol route information).

The controller 22 has one or more general-purpose processors such as Central Processing Units (CPUs) or one or more dedicated processors that are dedicated to specific processing. Alternatively, the controller 22 may have one or more dedicated circuits such as Field-Programmable Gate Arrays (FPGAs) or Application Specific Integrated Circuits (ASICs). The controller 22 is configured to perform overall control of the operations of the server apparatus 10 by operating according to the control/processing programs or operating according to operation procedures implemented in the form of circuits. Further, the controller 22 is configured to send and receive various kinds of information with the consumer terminal apparatus 11, the hub terminal apparatus 14, and the mobile shop 13, via the communication interface 20, to execute operations according to the present embodiment.

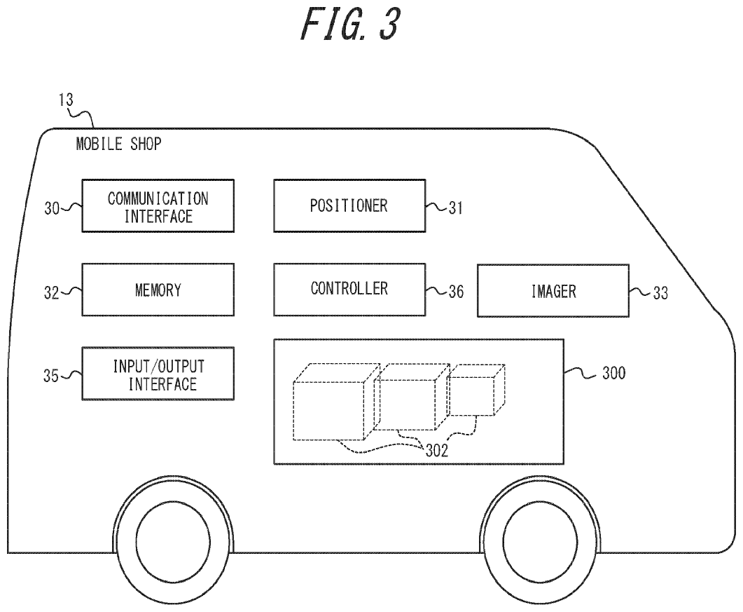

FIG. 3 illustrates a configuration example of the mobile shop 13. The mobile shop 13 is a multi-purpose vehicle that can be equipped with facilities suitable for an intended purpose in an interior space of the vehicle, and can be driven manually or automatically in a manned/unmanned manner. In the present embodiment, the mobile shop 13 is equipped with a shop facility 300 for selling items. The shop facility 300 is configured such that it is open to the outside of the vehicle and a consumer outside the vehicle can view and pick up items displayed inside the shop facility 300. Alternatively, the shop facility 300 is configured such that a consumer can enter the shop facility 300 to view and pick up items. The shop facility 300 may be managed and operated by a sales staff member of the mobile shop 13 on board or may be unmanned. The mobile shop 13, while patrolling the patrol route, parks at parking spots, or parks at any spots in response to requests from consumers, and sells items to consumers using the shop facility 300.

The shop facility 300 has loading spaces 302 for loading items. Items are, for example, tangible objects that can be sold at the shop, such as groceries, commodities, miscellaneous goods, books, clothes, or home appliances. The loading spaces 302 are spaces that have appropriately specified dimensions/shape for the loading of individual items. For example, the loading spaces 302 are cuboids with any appropriate aspect ratio, with the sizes of the cuboids being set in any appropriate number of levels in accordance with the sizes of items. The number of the loading spaces 302 of each size is set freely. The loading spaces 302 are, for example, spaces for single items that are appropriately partitioned in a display shelf, or spaces for single items that are appropriately partitioned in a storage cabinet. Each of the loading spaces 302 is loaded with a corresponding item having such dimensions/shape that the corresponding item can be accommodated.

The mobile shop 13 further has a communication interface 30, a positioner 31, a memory 32, an imager 33, an input/output interface 35, and a controller 36. Each of the components is connected, in a wired or wireless manner, via an in-vehicle network such as a Controller Area Network (CAN) or a dedicated line so that they can communicate with each other. Some or all of the communication interface 30, the positioner 31, the memory 32, the imager 33, the input/output interface 35, and the controller 36 may be directly provided in the mobile shop 13, or may be provided in a control apparatus, such as a car navigation system, that is attachable to and detachable from the mobile shop 13. Here, the mobile shop 13 may be driven by a driver, or driving may be automated at any appropriate level. The automation level is, for example, any of Level 1 to Level 5 as specified by the Society of Automotive Engineers (SAE).

The communication interface 30 has a communication module compliant with wired or wireless LAN standards and/or a module compliant with mobile communication standards such as the 4^{th} Generation (4G) or 5^{th} Generation (5G) standard. The mobile shop 13 connects to the network 15 via a mobile communication base station using the communication interface 30, and communicates information with other apparatuses via the network 15.

The positioner 31 is configured to measure the position of the mobile shop 13 and create positional information. The positional information is information that includes coordinates such as two-dimensional coordinates or three-dimensional coordinates and is used to identify the position on a map. In addition, the positional information is not limited to information on coordinates but may also include information such as that on the speed, patrol route, travel distance, or their amount of variation or variation ratio. The positioner 31 includes a receiver compatible with a satellite positioning system. The satellite positioning system that the receiver is compatible with may be the Global Positioning System (GPS), for example. Alternatively, the positioner 31 may include a sensor such as an acceleration sensor or a gyro sensor. Still alternatively, an apparatus such as a car navigation system may function as the positioner 31.

The memory 32 has, for example, a semiconductor memory, a magnetic memory, or an optical memory. The memory 32 functions as a main memory, an auxiliary memory, or a cache memory, for example. The memory 32 is configured to store any information used for control of the operations of the mobile shop 13. For example, the memory 32 stores programs such as application programs that are downloaded via the network 15 to provide various functions, and control/processing programs.

The imager 33 has one or more cameras and control circuits thereof that are disposed at positions from which it is possible to image the loading spaces 302 in the shop facility 300 and items displayed or stored in those spaces. The cameras provided in the imager 33 may be monocular cameras or may be stereo cameras.

The input/output interface 35 has an input interface that is configured to detect inputs from a user and send input information to the controller 36. The input interface is, for example, any suitable input interface including physical keys, capacitive keys, a touch screen provided integrally with a panel display, various pointing devices, a microphone that accepts audio input, a camera that takes captured images or image codes, an IC card reader, or the like. The input/output interface 35 also has an output interface that is configured to output, to the user, information created by the controller 36 and information received from the server apparatus 10. The output interface is, for example, any suitable output interface including a display that outputs image/video information, a speaker that outputs audio information, or a connection interface for connection with external output devices.

The controller 36 has one or more general-purpose processors such as CPUs or MPUs or one or more dedicated processors that are dedicated to specific processing. Alternatively, the controller 36 may have one or more dedicated circuits such as FPGAs or ASICs. The controller 36 is configured to perform overall control of the operations of the mobile shop 13 including the communication interface 30, the positioner 31, the memory 32, the imager 33, and the input/output interface 35, by operating in accordance with control/processing programs or operating in accordance with operation procedures implemented in the form of circuits. In a case in which the mobile shop 13 is driven automatically, the controller 36 sends information necessary for the travel of the mobile shop 13 to a control apparatus that controls the automatic driving of the mobile shop 13. In addition, the controller 36 is configured to send and receive various kinds of information with the server apparatus 10 and the consumer terminal apparatus 11 via the communication interface 30 to execute operations according to the present embodiment.

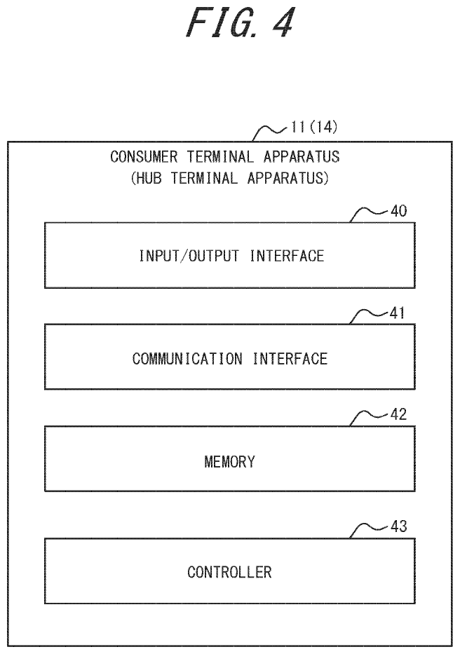

FIG. 4 illustrates a configuration example of the consumer terminal apparatus 11. The consumer terminal apparatus 11 is an information processing terminal apparatus such as a personal computer, a tablet terminal apparatus, or a smartphone. The consumer terminal apparatus 11 has an input/output interface 40, a communication interface 41, a memory 42, and a controller 43. It is to be noted that the configuration example of the consumer terminal apparatus 11 illustrated herein is also applicable to the hub terminal apparatus 14.

The input/output interface 40 has an input interface that is configured to detect inputs from a user and send input information to the controller 43. The input interface is, for example, any suitable input interface including physical keys, capacitive keys, a touch screen provided integrally with a panel display, various pointing devices, a microphone that accepts audio input, a camera that takes captured images or image codes, or the like. The input/output interface 40 also has an output interface that is configured to output, to the user, information created by the controller 43 and information received from the server apparatus 10. The output interface is, for example, any suitable output interface including an external or built-in display that outputs image/video information, a speaker that outputs audio information, or a connection interface for connection with external output devices.

The communication interface 41 has a communication module compliant with wired or wireless LAN standards and/or a module compliant with mobile communication standards such as the 4^{th} Generation (4G) or 5^{th} Generation (5G) standard. The consumer terminal apparatus 11 connects to the network 15 via a nearby router apparatus or mobile communication base station using the communication interface 41 and communicates information with other apparatuses via the network 15.

The memory 42 has, for example, a semiconductor memory, a magnetic memory, or an optical memory. The memory 42 functions as a main memory, an auxiliary memory, or a cache memory, for example. The memory 42 is configured to store any information used for operations of the consumer terminal apparatus 11. For example, the memory 42 stores programs such as application programs that are downloaded via the network 15 to provide various functions, and control/processing programs.

The controller 43 has one or more general-purpose processors such as CPUs or Micro Processing Units (MPUs) or one or more dedicated processors that are dedicated to specific processing. Alternatively, the controller 43 may have one or more dedicated circuits such as FPGAs or ASICs. The controller 43 is configured to perform overall control of the operations of the consumer terminal apparatus 11 by operating in accordance with control/processing programs or operating in accordance with operation procedures implemented in the form of circuits. In addition, the controller 43 is configured to send and receive various kinds of information with the server apparatus 10 and the mobile shop 13 via the communication interface 41 to execute operations according to the present embodiment.

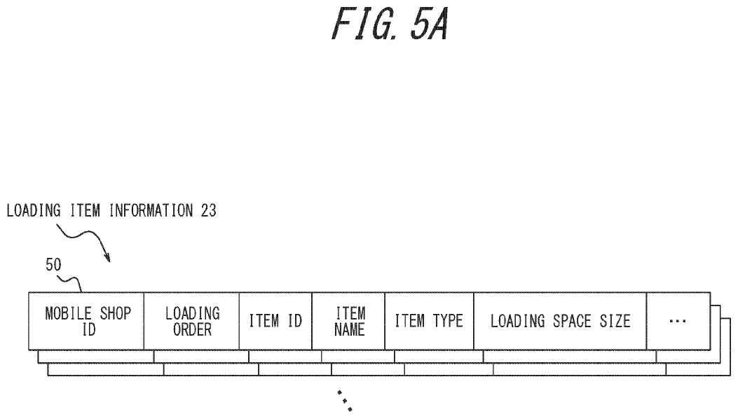

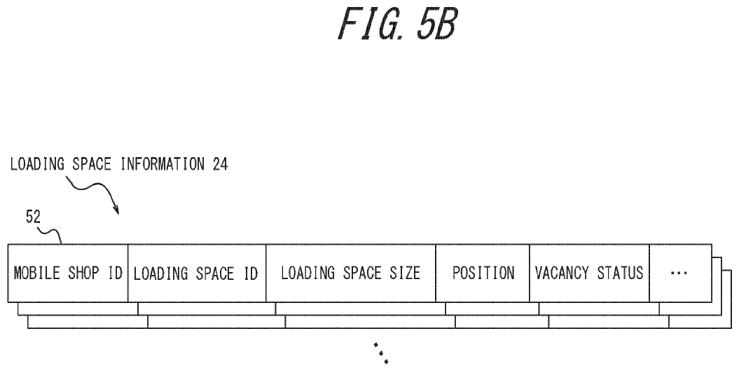

FIG. 5A schematically illustrates the loading item information 23 stored in the memory 21 of the server apparatus 10. The loading item information 23 includes records 50 for respective items loaded into the mobile shop 13. Each of the records 50 includes information items such as a mobile shop ID for identifying the mobile shop 13 in which the corresponding item is loaded, a loading order at the time of loading the items into the mobile shop 13, an item ID for identifying the item, an item name, an item type for the item, and a loading space size indicating the size of a minimum loading space for storing the item. The loading order is freely set in advance according to the sales strategy of the vendor. For example, the item type is any classified type such as groceries, commodities, miscellaneous goods, books, clothes, or home appliances, and may be further sub-classified. The loading space size is the volume, dimensions, and the like of the loading space, and is freely set in several levels. In a case in which multiple hubs 12 exist, the loading item information 23 for each of the hubs 12 is stored in the memory 21.

FIG. 5B schematically illustrates the loading space information 24 stored in the memory 21 of the server apparatus 10. The loading space information 24 includes records 52 for the respective loading spaces 302 of each mobile shop 13. Each of the records 52 includes information items such as a mobile shop ID for identifying the mobile shop 13, a loading space ID for identifying each of the loading spaces 302 in the mobile shop 13, a loading space size indicating the size of each of the loading spaces 302, a position of each of the loading spaces 302 in the shop facility 300 of the mobile shop 13, and a vacancy status of each of the loading spaces 302. It is to be noted that in a case in which the multiple mobile shops 13 exist, the loading space information 24 for each of the mobile shops 13 is stored in the memory 21.

The loading item information 23 and the loading space information 24 are used when items are loaded into the mobile shop 13 at the hub 12.

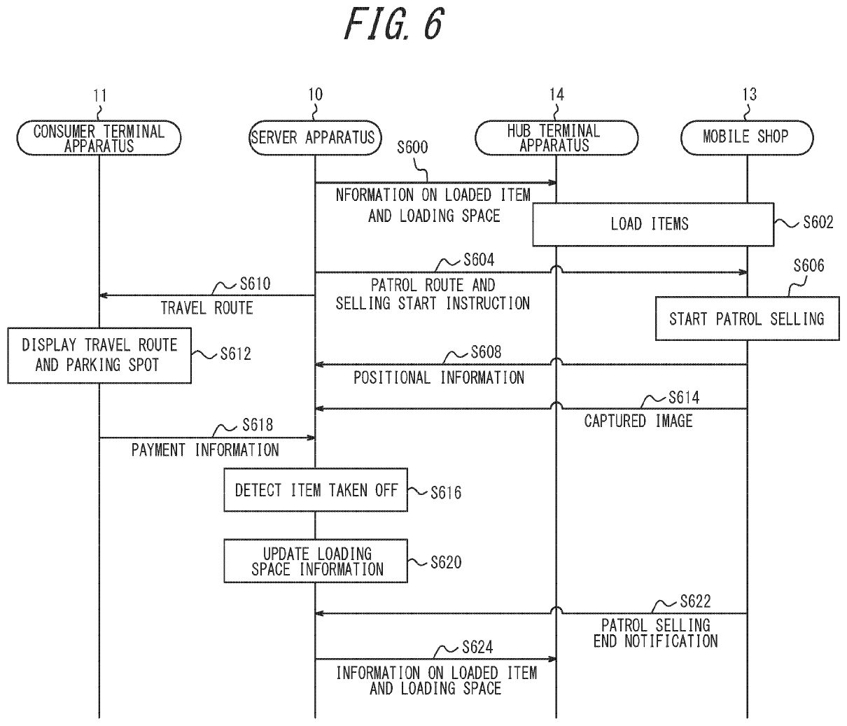

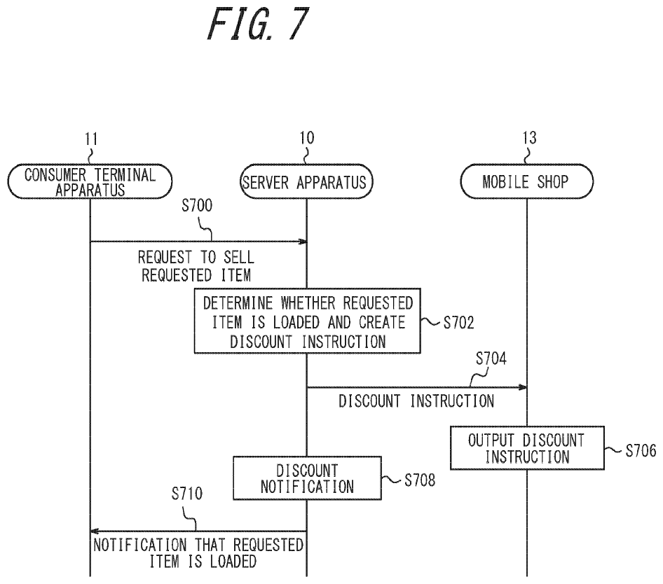

FIG. 6 and FIG. 7 are sequence diagrams illustrating an operation example of the information processing system 1. According to FIG. 6 and FIG. 7 an operation procedure for cooperative operation by the server apparatus 10, the mobile shop 13, the consumer terminal apparatus 11, and the hub terminal apparatus 14 is illustrated.

FIG. 6 illustrates an operation procedure of the information processing system 1 for one round of patrol selling by the mobile shop 13.

In Step S600, the controller 22 of the server apparatus 10 retrieves, from the loading item information 23 and the loading space information 24 in the memory 21, information on the loaded items and loading spaces corresponding to a combination of the hub 12 and the mobile shop 13, and sends the retrieved information to the hub terminal apparatus 14 via the communication interface 20. The controller 22 updates the loading space information 24 in the following procedure when the mobile shop 13 performs patrol selling. Accordingly, the loading space information 24 reflects the continually fluctuating vacancy status of each of the loading spaces 302. Thereby, the controller 22 selects, for each of the loading spaces 302 the vacancy status of which is identified by the loading space information 24, an item that matches the size of this loading space. Then, the controller 22 sends the record 50 of each of the selected items and the record 52 of the loading space where this item is loaded to the hub terminal apparatus 14. Thus, the controller 43 of the hub terminal apparatus 14 receives the information on the loaded items and the loading spaces via the communication interface 41.

In Step S602, the controller 43 of the hub terminal apparatus 14 outputs the information on the loaded items and loading spaces to an operator through the input/output interface 40 and thereby causes the operator to load the loading spaces 302 of the mobile shop 13 with the items that match the sizes of the loading spaces 302 according to the loading order. Alternatively, the controller 43 may cause an automated machine to load the loading spaces with the items by sending the information on the loaded items and loading spaces to a control computer of the automated machine for loading.

In Step S604, the controller 22 of the server apparatus 10 retrieves the patrol route information 25 from the memory 21, and sends information on the patrol route corresponding to the mobile shop 13, together with a selling start instruction, to the mobile shop 13 via the communication interface 20. Then, the controller 36 of the mobile shop 13 receives the information on the patrol route and the selling start instruction via the communication interface 30. The information on the patrol route includes information on the position of parking spots where the mobile shop 13 is to be parked for the purpose of selling items along the patrol route. Further, the selling start instruction includes information on a time period during which the mobile shop is to be parked at each parking spot.

In Step S606, the controller 36 of the mobile shop 13 causes the mobile shop 13 to start patrol selling by outputting the information on the patrol route and the position of parking spots to a driver using the input/output interface 35 to encourage driving, or by sending the information on the patrol route and the position of parking spots to the control apparatus for automatic driving to cause the control apparatus to execute automatic driving. The mobile shop 13 parks at the parking spots to sell items while traveling along the patrol route. Once the mobile shop 13 starts patrol selling, the controller 36 of the mobile shop 13 periodically acquires positional information from the positioner 31, and sends the acquired positional information to the server apparatus 10 via the communication interface 30 in Step S608. The controller 22 of the server apparatus 10 receives the positional information via the communication interface 20, and stores the position of the mobile shop 13 in the memory 21.

On the other hand, in Step S610, the controller 22 of the server apparatus 10 sends the information on the patrol route and the position of the parking spots of the mobile shop 13 to the consumer terminal apparatus 11 via the communication interface 20. Then, the controller 43 of the consumer terminal apparatus 11 receives the information on the patrol route and the position of the parking spots via the communication interface 41.

In Step S610, the controller 43 of the consumer terminal apparatus 11 outputs the information on the patrol route and the position of the parking spots to a consumer via the input/output interface 40. For example, a display shows the patrol route and the parking spots on a map. This allows the consumer to recognize the patrol route and the parking spots of the mobile shop 13, so that the consumer can go to the parking spots for shopping at the mobile shop 13.

Alternatively, the consumer may designate any spot along the patrol route, request the mobile shop 13 to park at the spot, and shop at the mobile shop 13 thus parked. For example, once the consumer makes an input to request parking of the mobile shop 13 at any spot on the patrol route to the input/output interface 40 of the consumer terminal apparatus 11, the controller 43 sends the positional information on the spot designated by the consumer and the parking request to the server apparatus 10 via the communication interface 41. Then, the controller 22 of the server apparatus 10 sends the positional information on the spot designated by the consumer and a parking instruction to the mobile shop 13 via the communication interface 20. Thereafter, the controller 36 of the mobile shop 13 encourages the driver to park the mobile shop 13 at the spot designated by the consumer or sends an instruction to the apparatus for automatic driving. Thereby, the mobile shop 13 is parked at the spot designated by the consumer.

In Step S614, the controller 36 of the mobile shop 13 sends images of the loading spaces 302 that are periodically captured by the imager 33, to the server apparatus 10 via the communication interface 30. The controller 36 may send a captured image every time the image is captured, or alternatively may send multiple captured images together. The controller 22 of the server apparatus 10 receives the captured images via the communication interface 20, and stores the captured images thus received in the memory 21.

In Step S616, the controller 22 of the server apparatus 10 detects an item, which is purchased by a consumer and taken from a loading space 302, based on temporal changes in the captured images of the loading spaces 302. Alternatively, the controller 36 of the mobile shop 13 may detect an item, which is taken from a loading space 302, based on temporal changes in the captured images and send this detection result to the server apparatus 10. Still alternatively, by virtue of a sales staff member who manages the shop facility 300 inputting information on a purchased item to the input/output interface 35, the controller 36 of the mobile shop 13 may send information on the item, which is taken from a loading space 302, to the server apparatus 10 via the communication interface 30.

Alternatively, in a case in which a consumer makes payment for an item using electronic payment, in Step S618, the consumer inputs an instruction to make payment for the item to the input/output interface 40 of the consumer terminal apparatus 11, and the controller 43 sends information necessary for electronic payment to the server apparatus 10 via the communication interface 41. Then, the controller 22 of the server apparatus 10 may receive the information necessary for the electronic payment via the communication interface 20, and detect the item taken from the corresponding loading space 302 in Step S616.

In Step S620, the controller 22 of the server apparatus 10 updates the loading space information 24 in the memory 21 based on the information on the item detected in Step S616. Based on the information on the items and the information on the loading spaces 302 associated with each other in Step S600, the controller 22 identifies the loading space 302 where the taken item had been loaded, and changes the vacancy status of this loading space 302 to a value indicating that it is vacant.

Steps S608 to S614 are repeated until one round of patrol selling ends. In addition, Steps S616 to S620 are repeated every time an item is purchased by a consumer and taken from a loading space 302.

When the mobile shop 13 finishes patrol selling and arrives at the hub 12, in Step S622, the controller 36 of the mobile shop 13 sends a patrol selling end notification to the server apparatus 10 via the communication interface 30. Alternatively, instead of the mobile shop 13, the controller 43 of the hub terminal apparatus 14 may send a patrol selling end notification for the mobile shop 13 to the server apparatus 10 via the communication interface 41. The controller 22 of the server apparatus 10 receives the patrol selling end notification via the communication interface 20.

In Step S624, the controller 22 of the server apparatus 10 sends information on the loaded items and loading spaces for the next round of patrol selling to the hub terminal apparatus 14 via the communication interface 20. In this situation, the controller 22 selects items to be loaded for the next round of patrol selling according to one or more vacancies in the loading spaces 302 of the mobile shop 13 created in the previous round of patrol selling. For example, from among items corresponding to the sizes of the vacant loading spaces 302, the controller 22 selects items to be loaded according to the loading order. Then, the controller 22 sends, to the hub terminal apparatus 14, information on the items to be loaded and information on the loading space 302 where each of these items is to be loaded. Thereafter, Step S602 and subsequent steps are repeated. In this manner, in the mobile shop 13, in preparation for the next round of patrol selling, other items are sequentially loaded into vacant loading spaces in which items purchased and taken in the previous round of patrol selling had been loaded.

Then, the mobile shop 13 performs the next round of patrol selling.

FIG. 7 illustrates a procedure executed when a consumer requests patrol selling of an item not loaded in the mobile shop 13. The procedure in FIG. 7 is executed between Step S606 (start of patrol selling by the mobile shop 13) and Step S622 (end of patrol selling by the mobile shop 13) illustrated in FIG. 6.

In a case in which a consumer finds that the mobile shop 13 is not loaded with a demanded item when shopping in the mobile shop 13, in Step S700, the consumer makes an input to request selling of the demanded item to the input/output interface 40 of the consumer terminal apparatus 11. In response to this, the controller 43 sends the request for selling of the demanded item to the server apparatus 10 via the communication interface 41. The controller 22 of the server apparatus 10 acquires demanded item information via the communication interface 20. The demanded item information includes information such as an item name and a vendor name.

In Step S702, before starting patrol selling, the controller 22 of the server apparatus 10 searches information on items loaded in the mobile shop 13 for the demanded item to determine whether the mobile shop 13 is loaded with the demanded item. Then, in a case in which the mobile shop 13 is not loaded with the demanded item, the controller 22 creates a discount instruction to discount the items that the mobile shop 13 is loaded with and is currently patrol selling. Thereafter, in Step S704, the controller 22 sends the discount instruction to the mobile shop 13 via the communication interface 20. The controller 36 of the mobile shop 13 receives the discount instruction via the communication interface 30.

In Step S706, the controller 36 of the mobile shop 13 outputs, through the input/output interface 35, an instruction to discount items loaded in the mobile shop 13. For example, for a sales staff member who manages the shop facility 300, the controller 36 displays a discount instruction for items on a display. The discount instruction for the items includes the item names of the items to be discounted, quantities, and the discount amount for each of the items to be discounted. Upon confirming the instruction, the sales staff member, for example, changes the price label of the items. Alternatively, in a case in which the shop facility 300 is provided with a display that shows the price of each item, the controller 36 may send, to a controller of the display, an instruction to change price information shown on the display. The discount amount may be set freely to, for example, a 10% discount or a 20% discount.

In Step S708, the controller 22 of the server apparatus 10 notifies consumer terminal apparatuses 11, other than the consumer terminal apparatus 11 which has requested patrol selling of the demanded item, of the discounting of the items that the mobile shop 13 is currently patrol selling. Alternatively, the controller 22 may send the same notification to the consumer terminal apparatus 11 which has requested patrol selling of the demanded item. For example, a website for introducing patrol selling is provided so as to be accessible to the consumer terminal apparatuses 11, and the controller 22 may use this website to notify the item discount together with the position of the mobile shop 13. Thereby, it is possible to sell the discounted items more reliably.

When, as a result of execution of Steps S700 to S708, the items that the mobile shop is currently patrol selling are purchased, and thus a vacancy is created in the loading spaces 302 and it becomes possible to load the demanded item in the next round of patrol selling, the controller 22 of the server apparatus 10 sends, to the consumer terminal apparatus 11 which has requested the demanded item, a notification that the demanded item is to be loaded. For example, from detection of a vacant loading space in Step S616 of FIG. 6 until the start of the next round of patrol selling, in Step S710, the controller 22 sends, to the consumer terminal apparatus 11 which has requested the demanded item, the notification that the demanded item is to be loaded. Thereby, it is possible to notify a consumer of availability of the demanded item at an appropriate time, and thus improve convenience for the consumer.

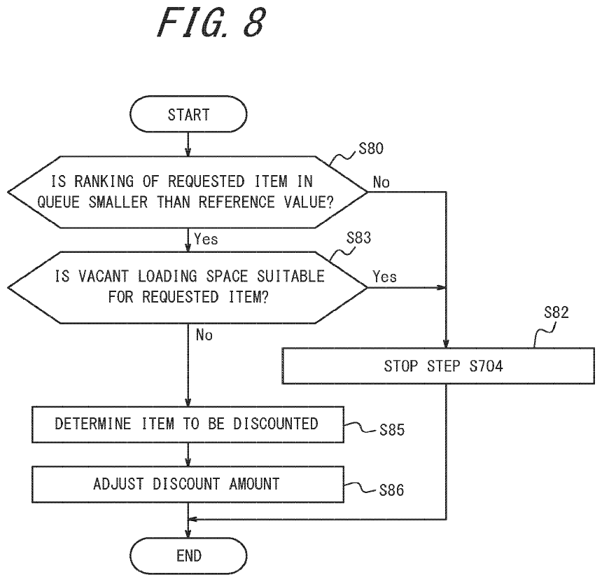

FIG. 8 is a flowchart illustrating a detailed procedure for the discount instruction creation processing in Step S702 of FIG. 7.

In Step S80, the controller 22 of the server apparatus 10 determines whether the demanded item is likely to be loaded at a relatively early time. For example, the controller 22 creates a queue of items to be loaded in the next round of patrol selling on a per item or per item type basis. Then, assuming that the ranking of the demanded item in ascending order in the queue is N (N is a natural number), the controller 22 determines whether N is smaller than a freely specified reference value. In a case in which N is smaller than the reference value (Yes), the controller 22 proceeds to Step S83. On the other hand, in a case in which N is equal to or larger than the reference value (No), the controller 22 proceeds to Step S82 and stops Step S704 without creating a discount instruction.

The reference value to be compared with the ranking N of the demanded item in the queue can be an average value of the number of items, which are purchased in one round of patrol selling, on a per item type basis; or a value that deviates from the average value by a given extent. In this way, by virtue of the controller 22 creating a discount instruction on condition that it is reasonably likely that the demanded item would be loaded in the next round of patrol selling, it is possible to reliably load the demanded item by discounting and selling off the items in the current patrol selling when it is likely that the demanded item would be loaded in the next round of patrol selling. On the other hand, it is possible to secure profits by not discounting the items in the current patrol selling when it is not likely that the demanded item would be loaded in the next round of patrol selling.

In Step S83, the controller 22 of the server apparatus 10 determines whether any of the vacant loading spaces 302, as determined in Step S620 of FIG. 6, can accept the demanded item. Then, in a case in which a vacant loading space 302 can accept the demanded item (Yes), the controller 22 proceeds to Step S82 to stop Step S704 without creating a discount instruction. On the other hand, in a case in which no vacancy exists or no vacant loading space 302 can accept the demanded item (No), the controller 22 proceeds to Step S85. In this way, the controller 22 creates a discount instruction on condition that the mobile shop 13 does not have a vacant loading space for loading the demanded item. If the mobile shop 13 has a vacant loading space that can accept the demanded item, it is not necessary to discount other items in order to create a vacancy. Accordingly, in this case, no discount instruction is created, thereby making it possible to prevent profit pressure due to unnecessary discounting.

In Step S85, the controller 22 of the server apparatus 10 determines items to be discounted according to the attributes of the demanded item or a space required for loading the demanded item. In a case in which the demanded item is, for example, a food item that needs to be kept warm or heated, or a food item that needs to be refrigerated or frozen, the demanded item needs to be loaded to a loading space of the shop facility 300 that is equipped with a temperature control function. Accordingly, in order to promote selling of items which are loaded in such loading spaces and have the same attributes as those of the demanded item, and thereby make such loading spaces vacant, the controller 22 sets the items having the same attributes as items to be discounted. Alternatively, the controller 22 sets items, which have the same or similar size as the demanded item and are loaded in loading spaces of the same or similar size as that of the loading space which can accept the demanded item, as items to be discounted and thus sells them more reliably. According to such procedures, by discounting only those items for which sales should be promoted in order to load the demanded item, it is possible to sell them more reliably whilst securing profit without discounting other items.

In Step S86, the controller 22 of the server apparatus 10 adjusts the discount amount.

In one discount amount adjustment example, the controller 22 changes the discount amount according to one or more vacancies in the loading spaces of the mobile shop 13. In a case in which multiple demanded items are demanded by a consumer and the number of vacant loading spaces, determined in Step S620 of FIG. 6 is not sufficient to accept all of the demanded items, the controller 22 adjusts the discount amount according to the difference between the number of demanded items and the number of vacant loading spaces. For example, in a case in which there are M (M is a natural number) vacancies with respect to N (N is a natural number) demanded items, the controller 22 determines the discount amount by multiplying an initial value of the discount amount by (N−M)/N (M is equal to or smaller than N). According to this method, it is possible to reduce the discount amount as the degree of insufficiency of vacant loading spaces is smaller, and increase the discount amount as the degree of insufficiency of vacant loading spaces is larger. Accordingly, it is possible to more reliably sell items in the current patrol selling and create vacant loading spaces when the degree of insufficiency of vacant loading spaces is larger.

In another discount amount adjustment example, the controller 22 changes the discount amount according to the remaining segment of the patrol route of the mobile shop 13. The controller 22, for example, uses the length of the patrol route acquired from the patrol route information 25 of the mobile shop 13 and the position of the mobile shop 13 acquired from the mobile shop 13, to derive the length of the remaining segment of the patrol route. Then, assuming that the length of the whole patrol route is X (X is a positive number) and the length of the remaining segment is Y (Y is a positive number), the controller 22 determines the discount amount by multiplying the initial value of the discount amount by 1−Y/X. According to this method, it is possible to reduce the discount amount to secure a profit margin when the remaining segment is long because there are many chances to sell items in the current patrol selling and create vacant loading spaces, whereas it is possible to increase the discount amount to promote selling of items when the remaining segment is short because there are few chances to sell items in the current patrol selling and create vacant loading spaces.

It is noted that the mathematical formulae that are described above and used for adjusting the discount amount in Step S86 are merely examples; thus, the mathematical formulae are not limited to the above examples and any examples exhibiting the same operation and effect are also included in the scope of the present disclosure.

In the above description, the timing at which the consumer requests patrol selling of a demanded item may be a timing at which the consumer goes to the mobile shop 13 which is parked or may be any other timing. For example, the web site provided by the server apparatus 10 may be configured such that a consumer can browse items that are loaded in the mobile shop 13 during the patrol selling, and the consumer may request patrol selling of the demanded item upon confirming that the mobile shop 13 is not loaded with the demanded item when browsing items that the mobile shop 13 is patrol selling, using the consumer terminal apparatus 11.

As has been described above, according to the present embodiment, by discounting loaded items, it is possible to sell items that the mobile shop 13 is currently patrol selling more reliably, create vacant loading spaces, and thereby load demanded items into vacant loading spaces in the next round of patrol selling. Accordingly, it is possible to provide the demanded items to the consumer at an early timing and, at the same time, allow the vendor to enhance business opportunities. As a result, this improves the convenience for the consumer and sales efficiency when selling items.

In the above embodiment, processing/control programs which prescribe the operations of the controller 43 of the consumer terminal apparatus 11, the consumer terminal apparatus 11, and the controller 43 of the hub terminal apparatus 14 may be stored in the memory of the server apparatus 10 or a memory of another server apparatus and downloaded to each of the terminal apparatuses by way of the network 15, or alternatively may be stored in a portable and non-transitory recording/storage medium, which is readable by each of the terminal apparatuses, and read from the medium by each of the terminal apparatuses. Further, processing/control programs which prescribe the operations of the controller 36 of the mobile shop 13 may be stored in the memory of the server apparatus 10 or a memory of another server apparatus and downloaded to the controller 36 of the mobile shop 13 by way of the network 15, or alternatively may be stored in a portable and non-transitory recording/storage medium, which is readable by the controller 36, and read from the medium by the controller 36.

Although an embodiment has been described above based on the drawings and examples, it should be noted that various modifications and revisions may be implemented by those skilled in the art based on the present disclosure. Accordingly, such modifications and revisions are included within the scope of the present disclosure. For example, functions and the like included in the means, steps, and the like can be rearranged so as not to conflict with each other, and the multiple means, steps, and the like can be combined into one or divided.

1. A server apparatus comprising:
a communication interface; and
a controller configured to send and receive information via the communication interface, wherein
while a mobile shop which is configured to be loaded with items according to vacant spaces is loaded with one or more first items and performs patrol selling, the controller sends a discount instruction, to the mobile shop, to discount the one or more first items upon receipt of a request, from a terminal apparatus, for patrol selling of a second item not loaded in the mobile shop.

2. The server apparatus according to claim 1, wherein the controller is configured to send the discount instruction to the mobile shop on condition that the second item is to be loaded into the mobile shop in patrol selling performed after the patrol selling of the one or more first items.

3. The server apparatus according to claim 1, wherein the controller is configured to send the discount instruction to the mobile shop on condition that the mobile shop does not have a vacant space for loading the second item.

4. The server apparatus according to claim 1, wherein the controller is configured to change the discount amount in the discount instruction according to a vacancy status for spaces in the mobile shop.

5. The server apparatus according to claim 1, wherein the controller is configured to change the discount amount in the discount instruction according to a remaining segment of the patrol selling of the one or more first items.

6. The server apparatus according to claim 1, wherein the controller is configured to determine, from among the one or more first items, an item to be discounted in the discount instruction according to an attribute of the second item or a space required for loading the second item.

7. The server apparatus according to claim 1, wherein the controller is configured to notify another terminal apparatus of discounting of the one or more first items.

8. The server apparatus according to claim 1, wherein the controller is configured to notify the terminal apparatus that the mobile shop is to be loaded with the second item.

9. An information processing system comprising the server apparatus according to claim 1 and the mobile shop.

10. A control apparatus mounted in a mobile shop that is configured to be loaded with items according to vacant spaces, wherein
the control apparatus is configured to send and receive information with a server apparatus and control the mobile shop,
while the mobile shop is loaded with one or more first items and performs patrol selling, a discount instruction to discount the one or more first items is sent from the server apparatus upon receipt, by the server apparatus, of a request, from a terminal apparatus, for patrol selling of a second item not loaded in the mobile shop, and
upon receiving the discount instruction, the control apparatus outputs information for discounting the one or more first items.

11. A non-transitory storage medium that is readable by a control apparatus of a mobile shop and stores therein a program which, when executed by the control apparatus, causes the control apparatus to operate as the control apparatus according to claim 10.

12. A mobile shop comprising the control apparatus according to claim 10.

13. An operating method for an information processing system including a mobile shop configured to be loaded with items according to vacant spaces and a server apparatus configured to send and receive information with the mobile shop, the operating method comprising:
sending, by the server apparatus, while the mobile shop is loaded with one or more first items and performs patrol selling, a discount instruction to discount the one or more first items upon receipt of a request, from a terminal apparatus, for patrol selling of a second item not loaded in the mobile shop; and
outputting, by the mobile shop, information for discounting the one or more first items upon receiving the discount instruction.

14. The operating method according to claim 13, wherein the server apparatus sends the discount instruction to the mobile shop on condition that the second item is to be loaded into the mobile shop in patrol selling performed after the patrol selling of the one or more first items.

15. The operating method according to claim 13, wherein the server apparatus sends the discount instruction to the mobile shop on condition that the mobile shop does not have a vacant space for loading the second item.

16. The operating method according to claim 13, wherein the server apparatus changes the discount amount in the discount instruction according to a vacancy status for spaces in the mobile shop.

17. The operating method according to claim 13, wherein the server apparatus changes the discount amount in the discount instruction according to a remaining segment of the patrol selling of the one or more first items.

18. The operating method according to claim 13, wherein the server apparatus determines, from among the one or more first items, an item to be discounted in the discount instruction according to an attribute of the second item or a space required for loading the second item.

19. The operating method according to claim 13, wherein the server apparatus notifies another terminal apparatus of discounting of the one or more first items.

20. The operating method according to claim 13, wherein the server apparatus notifies the terminal apparatus that the mobile shop is to be loaded with the second item.
